(19) United States
(12) Patent Application Publication
(10) Pub. No.: US 2006/0206635 A1
(43) Pub. Date: Sep. 14, 2006

(54) DMA engine for protocol processing

(75) Inventors: Thomas Alexander, Mulino, OR (US); Marc Alan Quattromani, Beaverton, OR (US); Alexander Rekow, Portland, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: PMC-Sierra, Inc., Santa Clara, CA (US)

(21) Appl. No.: 11/373,858

(22) Filed: Mar. 10, 2006

Related U.S. Application Data
(60) Provisional application No. 60/660,727, filed on Mar. 11, 2005.

(51) Int. Cl. G06F 13/28

(52) U.S. Cl. 710/22

(57) ABSTRACT

A DMA engine, includes, in part, a DMA controller, an associative memory buffer, a request FIFO accepting data transfer requests from a programmable engine, such as a CPU, and a response FIFO that returns the completion status of the transfer requests to the CPU. Each request includes, in part, a target external memory address from which data is to be loaded or to which data is to be stored; a block size, specifying the amount of data to be transferred; and context information. The associative buffer holds data fetched from the external memory; and provides the data to the CPUs for processing. Loading into and storing from the associative buffer is done under the control of the DMA controller. When a request to fetch data from the external memory is processed, the DMA controller allocates a block within the associative buffer and loads the data into the allocated block.

### CROSS-REFERENCES TO RELATED APPLICATIONS

The present application claims benefit under 35 USC 119(e) of U.S. provisional application No. 60/660,727, attorney docket number 016491-005400US, filed Mar. 11, 2005, entitled “Efficient Augmented DMA Controller For Protocol Processing”, the content of which is incorporated herein by reference in its entirety.

### BACKGROUND OF THE INVENTION

The present invention is related to a method and apparatus for deterministically enhancing the throughput of a programmable system employing CPUs (or other programmable engines that have similar characteristics), in particular when applied to the processing of packets at high speeds.

Network communication systems frequently employ software-programmable engines, such as Central Processing Units (CPUs), in order to perform high-level processing operations on received and transmitted packets. The use of such programmable engines is desirable because of the complexity of the operations that must be performed for higher-layer protocols (such as the Transmission Control Protocol, TCP, or the Hyper Text Transfer Protocol, HTTP) as well as the need to change or enhance the processing functions when protocol extensions or improvements are adopted by the industry. Embodying the processing functions in software rather than hardware leads to both reduced cost and risk, as well as enhanced flexibility and capability to support upgrades to the equipment after it has been deployed in the field.

Processing performed by such CPUs may consist of packet header parsing and analysis functions, packet routing and switching functions, traffic management and packet forwarding functions, network state maintenance and update functions, control functions, and so on. Network communication systems have been known to employ CPUs for a broad range of activities, ranging from simple control-only tasks (where the packet data are handled by hardware, but the control of the latter hardware is performed in software) to complete packet processing functions from the link layer protocols all the way through to the application layer.

In such network processing situations, the performance and throughput of the CPU or CPUs becomes a significant determinant of the overall system throughput, and it will then be essential to ensure that the software processing speed is capable of handling the rate at which data must be received or transmitted. Unlike general-purpose computing systems, network processing systems must carry out their tasks in a very deterministic and bounded manner, governed by the rate at which packets are transmitted on the physical communication links. Failure to keep up with the fundamental link rate often means that packets will be dropped or lost, which is usually unacceptable in advanced networking systems. A network processing system represents an extreme case of a hard real-time system, where all software functions must be executed within a deterministic and known time in order to satisfy the constraints on the system.

Therefore, it is necessary to provide means to ensure that the performance and utilization of the CPU or CPUs performing network processing functions is maximized. Different approaches have been taken to achieve this goal. One known approach is the use of a much higher-performance CPU in order to reach the necessary level of throughput. This is, however, very expensive to implement. Another known approach is the use of multiple lower-performance CPUs to carry out the required tasks; however, this approach suffers from a large increase in software complexity in order to properly partition and distribute the tasks among the CPUs, and ensure that throughput is not lost due to inefficient inter-CPU interactions. Another approach is to use a class of CPUs known as Network Processors. These combine more-or-less traditional CPUs with complex auxiliary hardware assist functions, such as table look-up engines, queue engines, header processing engines, and so on. The combination of these hardware assist functions with the software on the CPU is then engineered to achieve the necessary processing rates. However, these systems have proven to be limited in scope, as the special-purpose hardware assist functions often limit the tasks that can be performed efficiently by the software, thereby losing the advantages of flexibility and generality.

It is also possible to modify and augment the CPU and associated logic to adapt them to the requirements of network processing, without losing generality. For instance, the internal data paths may be modified to accommodate the requirements of packet processing functions. Several approaches have been used: software transparent methods, software managed methods, or some mix of the two.

One significant source of inefficiency while performing packet processing functions is the latency of the memory subsystem that holds the data to be processed by the CPU. In this context, latency refers to the time taken for a memory subsystem to return a data word being read, or accept a data word to be written, after a read or write command has been issued by the CPU. Note that write latency can usually be hidden using caching or buffering schemes; read latency, however, is more difficult to deal with.

Memory latency is typically dealt with in general-purpose computing systems by utilizing hierarchies of memories (mass storage, main memory, caches, buffers, registers, etc.) to mitigate and even hide the effect of read latencies in the overall memory subsystem. Large amounts of research and implementation work has been done to analyze and quantify performance gains resulting from such hierarchies. In addition, general-purpose computing workloads are not subject to the catastrophic failures (e.g., packet loss) of a hard real time system, but only suffer from a gradual performance reduction as memory latency increases. The problem and its solution can hence be considered to be well addressed in the context of general-purpose computing workloads.

In packet processing systems, however, little work has been done towards efficiently dealing with memory latency. The constraints and requirements of packet processing prevent many of the traditional approaches taken with general-purpose computing systems, such as caches, from being adopted. However, the problem is quite severe; in most situations, the latency of a single access is equivalent to tens or even hundreds of instruction cycles of the CPU, and hence packet processing systems can suffer tremendous performance loss if they are unable to reduce the effects of memory latency. In fact, many of the hardware assist functions provided in Network Processors (for instance, table look-up engines) are present solely to eliminate the need for the CPU to directly access memory. Unfortunately, as already noted, such hardware assist functions greatly limit the range of packet processing problems to which the CPU can be applied while still maintaining the required throughput. A generalized method by which memory latency can be dealt with and prevented from affecting the throughput of the CPU when performing packet processing functions is much preferable.

A key attribute of hard real time packet processing systems is the need to accurately quantify the performance of individual components that lie in the data path. Packet processing pipelines need determinism in order to balance processing times and throughputs over the stages within these pipelines, and to avoid having to significantly overdesign stages to guarantee throughput. In order to design and implement a packet processing system that will not suffer from packet loss, therefore, it is necessary to ensure that the hardware and software components offer latencies and throughputs that are predictable for the different types of traffic that are expected to be encountered.

For example, consider a packet processing pipeline, where one of the stages offers statistical rather than deterministic throughput. If this stage is assumed to perform its functions at much better than the packet arrival rate for 90% of the time, but for 10% of the time it functions 10× worse than the packet arrival rate, then for lossless operation this stage must be preceded by a packet buffer containing 10B packets, where B is the maximum number of worst-case packets that can arrive in a burst. Taking the specific case of Fast Ethernet, with 1500 byte packets and a 100 Mb/s link rate, if B is assumed to be 100 packets, the buffer must hold 150,000 bytes and will increase the overall latency variation in the system by 12 milliseconds. Neither figure is considered to be small.

Most such conventional systems may be classified under two categories: software-controlled caches, which extend a traditional programmer-invisible cache to accommodate software control of its behavior; and enhanced DMA controllers, which use advanced control mechanisms for improving the efficiency and reducing the software overhead in a standard DMA controller. The following public-domain publications and patents, the contents of which are incorporated by reference in their entirety disclose methods for improving performance in DMA:
Hallnor, Erik G, et. al. “A Fully Associative Software-Managed Cache Design,” Technical Report, Department of Electrical Engineering and Computer Science, University of Michigan, Ann Arbor
Jacob, Bruce, “Software-Managed Caches: Architectural Support for Real-Time Embedded Systems,” Technical Report, Electrical Engineering Department, University of Maryland, College Park
Moritz, Csaba A., et. al. “Hot Pages: Software Caching for Raw Microprocessors,” Technical Report, Laboratory for Computer Science, Massachusetts Institute of Technology, Cambridge.
U.S. Pat. No. 6,219,759: “Cache memory system”
U.S. Pat. No. 5,875,352: “Method and apparatus for multiple channel direct memory access control”
U.S. Pat. No. 5,283,883: “Method and direct memory access controller for asynchronously reading/writing data from/to a memory with improved throughput”
U.S. Pat. No. 6,230,241: “Apparatus and method for transferring data in a data communications device”
U.S. Pat. No. 5,434,976: “Communications controller utilizing an external buffer memory with plural channels between a host and network interface operating independently for transferring packets between protocol layers”
U.S. Pat. No. 5,377,338: “Apparatus and methods for reducing numbers of read-modify-write cycles to a memory, and for improving DMA efficiency”
U.S. Pat. No. 5,966,734: “Resizable and relocatable memory scratch pad as a cache slice”
U.S. Pat. No. 5,345,560: “Prefetch buffer and information processing system using the same”
U.S. Pat. No. 6,131,155: “Programmer-visible uncached load/store unit having burst capability”
U.S. Pat. No. 6,304,962: “Method and apparatus for prefetching superblocks in a computer processing system”
U.S. Pat. No. 6,321,328: “Processor having data buffer for speculative loads”

Most of the work in software-managed caches relates to improving performance with compiled code, e.g., by using compiler hints for controlling cache behavior in software. U.S. Pat. No. 6,219,759 describes a DMA controller operating under the control of a cache controller. No extensions to software management, or packet processing requirements, is discussed. U.S. Pat. No. 5,875,352 refers to the caching of DMA state information (i.e., information directly relating to the control of the DMA controller itself). This patent does not discuss or point to the possibility of caching the data fetched by the DMA in any form. U.S. Pat. No. 5,283,883 couples a standard DMA with dedicated memory buffers to facilitate automatic read-ahead (prefetching) of requested data. No software involvement is described. U.S. Pat. No. 6,230,241 describes a mechanism for fast copying of data. The mechanism uses a combination of a standard CPU cache memory and a DMA controller. No reference to software prefetching or writeback is made, or any extensions that can support packet processing. U.S. Pat. No. 6,321,328 discloses a data buffer operating in parallel to a standard cache (similar to the arrangement disclosed in U.S. Pat. No. 6,131,155) that is used to hold speculatively prefetched data. This arrangement is equivalent to splitting a cache into two sections, with one section being loaded in a software-transparent manner and the other being loaded in response to software prefetch instructions. No DMA controller capabilities are disclosed.

As described above, software-programmable engines such as CPUs need a simple method of reducing the impact of memory access latency on throughput. This is especially true with high-speed CPUs (e.g., with greater than 300 MHz clock rates) used to process high-rate data communication streams (e.g., at rates of 1 gigabit/second or more) with modem memory technologies such as Synchronous Dynamic RAM (SDRAM). In this case, the latency of the SDRAM can approach a large multiple of the CPU clock rate, with the result that direct accesses made to SDRAMs by the CPU will produce significant reductions in efficiency and utilization.

For example, a typical Double Data Rate (DDR) SDRAM can require a data read latency, as measured from the time a read command is issued by the CPU to the time that the requested data is returned to the CPU, of about 50 to 60 nanoseconds. With a typical 500 MHz CPU, having a clock cycle time of 2 nanoseconds, between 25 and 30 cycles will be wasted in waiting for data to be returned every time a memory access is made. If just 10 memory accesses are assumed to be required during the processing of a single packet, a 500 MHz CPU would waste 250 to 300 instruction cycles of processing time per packet. As a 1 Gb/s Ethernet data link transfers data at a maximum rate of approximately 1.5 million packets per second, attempting to process Ethernet data using this CPU and SDRAM combination would result in 75% to 90% of the available processing power being wasted due to the memory latency. This is clearly a highly undesirable outcome, and some method must be adopted to reduce or eliminate the significant loss of processing power due to the memory access latency.

When applied to networking, any method of improving CPU performance must satisfy the following additional requirements: i) be able to cope with packet processing workloads (low spatial and temporal locality of incoming traffic, short burst lengths, packet header modifications, etc.); ii) enable the deterministic performance gains required by hard real time packet processing systems, as already noted; iii) be applicable to multiple CPUs integrated into one device; multiple CPUs are commonly employed to deal with high network data rates, as the processing rate of a single CPU is difficult to increase in proportion to the rate at which network speeds have increased; iv) involve relatively low software overhead; since protocol processing in real-time is a complex programming task in itself, adding the burden of dealing with hardware engines that must be controlled and monitored can make the task insupportable. A recent development in network packet processing approaches is to use multi-threading to improve the efficiency of CPUs when dealing with multiple packets concurrently. A mechanism to enhance memory utilization should hence preferably support multi-threading.

It is important to address the memory latency impact on CPU efficiency, while accommodating the additional requirements listed above. Three general approaches have been used so far to address the issue of memory latency overhead in packet processing systems, namely software-transparent approaches, software-controlled approaches, and mixed approaches.

A software-transparent approach attempts to solve the problem entirely in hardware and does not rely on any sort of programmer involvement. This approach usually relies upon some type of cache structure, along with various sophisticated methods of predicting memory access patterns in order to improve the efficiency of the caches themselves. Caching is well known to be suitable for general-purpose computing workloads, and can be extended to cover numerical computation workloads as well. However, caching is quite unsuitable for network processing workloads, especially in protocol processing and packet processing situations, where the characteristics of the data and the memory access patterns are such that caches offer non-deterministic performance, and (for worst-case traffic patterns) may offer no speedup.

A software-controlled approach employs data transfer engine such as a Direct Memory Access (DMA) controller. This approach places the burden of deducing and optimizing memory accesses directly on the programmer, who is required to write software to orchestrate data transfers between the CPU and the memory, as well as to keep track of the data residing at various locations. These normally offer far higher utilization of the CPU and the memory bandwidth, but are cumbersome and difficult to program.

A mixed approach attempts to combine some aspects of the two mechanisms above in order to increase utilization without concurrently driving up programmer workload. Software-controlled prefetching, direct-deposit into caches, intelligent DMAs, etc. have all been described in the literature. Unfortunately, the approaches taken so far have been somewhat ad-hoc and suffer from a lack of generality. Further, they have proven difficult to extend to processing systems that employ multiple CPUs to handle packet streams.

Another technique commonly used to hide memory latency is the use of multiple thread contexts in a single CPU coupled with automatic thread switching. Essentially, if one thread stalls due to a long memory read latency, the processor can immediately switch to some other (unblocked) thread to continue doing useful work until the requested read data is returned. This is a viable technique for some (but not all) packet processing workloads, especially those that can be easily decomposed into separate and independent tasks, with no data dependencies between the tasks in a single thread. This method is considered to be orthogonal to the three approaches listed above, as it can be applied to further reduce the memory latency penalty for any of them (as well as for the approach disclosed in the present invention).

Caches

Caches have the following benefits:
1. Fully software transparent: no programmer overhead required. This is a significant benefit; it considerably eases the burden of bookkeeping on the programmer.
2. Caches are optimized for detecting and exploiting locality, that is, the tendency of computational workloads to make accesses in predictable patterns rather than in a totally random manner. As caches are completely hardware-based, they can even exploit locality that is not directly visible to the programmer.
3. Simple and regular structure, well understood design, and can be made as large or small as needed. Caches have been understood and used for a long time, and there is a large body of literature that deals with their design and optimization.
4. Extension to multi-processor devices is reasonably straightforward; the techniques for creating cache structures capable of supporting multiple concurrently-running CPUs are also well-understood and relatively straightforward.

Caches, however, suffer from the following disadvantages:
1 They provide statistical but not deterministic improvements. This is a crucial issue when dealing with networking applications. Typical network traffic patterns are self-similar, and consequently produce long bursts of pathological packet arrival patterns that can be shown to defeat standard caching algorithms. These patterns will therefore lead to packet loss if the statistical nature of caches are relied on for performance. Further, standard caches always pay a penalty on the first fetch to a data item in a cache line, stalling the CPU for the entire memory read latency time. The worst-case latency incurred by a standard cache is hence many times greater than the average latency.
2. Classic cache management algorithms do not predict network application locality well. Networking and packet processing applications also exhibit locality, but this is of a selective and temporal nature and quite dissimilar to that of general-purpose computing workloads. In particular, the traditional set-associative caches with least recently used replacement disciplines are not optimal for packet processing. Further, the typical sizes of the data structures required during packet processing (usually small data structures organized in large arrays, with essentially random access over the entire array) are not amenable to the access behavior for which caches are optimized.
3. Software transparency is not always desirable; programmers creating packet processing software can usually predict when data should be fetched or retired. Standard caches do not offer a means of capturing this knowledge, and thus lose a significant source of deterministic performance improvement.
   Accordingly, caches are not well suited to handling packet processing workloads.
   DMA Controllers

DMA controllers are arrangements whereby a CPU can, under program control, instruct that data be transferred from one place to another. A DMA controller is generally used to transfer data from an input-output device to main memory, or vice versa; however, it can also be used to perform data copies within main memory, or to transfer data between an auxiliary (e.g., a scratch-pad) memory and main memory, and so on. They are frequently used to eliminate the effects of memory latency from the CPU; as the CPU only needs to generate the instructions initiating the DMA transfer, it does not have to bear the impact of long memory access times.

In the context of networking, a DMA-based approach to eliminating the memory latency overhead offers the following benefits:
1. Completely programmer controlled, and supports programming tricks to optimize access. This can offer significant advantages when attempting to optimize the performance of a packet processing system.
2. Does not stall the CPU while fetching/storing data. A standard DMA operates completely independently of the CPU, and hence the CPU sees no impact due to memory latency, regardless of how large the ratio of latency to CPU cycle time becomes, provided that the program structure and the workload enables DMA operations to be scheduled sufficiently in advance of when the data are actually needed.
3. Efficiently handles data structures of different sizes. DMA controllers can be optimized for the handling of large data structures as well as small ones, and hence are well suited for the data structure sizes commonly encountered in networking.
4. Can be designed to directly support complex data structures, such as linked lists, trees, tables, descriptors, etc. DMA controllers can be adapted to specific applications and the data structures employed therein, resulting in significant improvements in performance. There is a limit to how much this capability can be utilized, however. If the DMA is made excessively application-specific, then it will result in the same loss of generality as seen in Network Processors with application-specific hardware acceleration engines.
5. Very efficient at accessing memory. A typical issue with alternative methods (such as cache-based approaches) is that additional data are fetched from the main memory but never used. This is a consequence of the limitations of the architectures employed, which would become too complex if the designer attempted to optimize the fetching of data to reduce unwanted accesses.

However, DMA engines suffer from the following defects, when applied to networking:
1. Relatively high SW overhead: typical general-purpose DMA controllers require a considerable amount of programmer effort in order to set up and manage data transfers and ensure that data are available at the right times and right locations for the CPU to process. In addition, DMA controllers usually interface to the CPU via an interrupt-driven method for efficiency, and this places an additional burden on the programmer.
2. Bookkeeping required to keep track of memory areas, etc. The software is required to allocate scratchpad memory areas and manage their assignment to data blocks being fetched or stored by the DMA, as well as to keep track of which memory areas are occupied by valid data and which ones are available for use. These bookkeeping functions have usually been a significant source of software bugs as well as programmer effort.
3. Not easy to extend to multi-CPU and multi-context situations. Due to the fact that DMA controllers must be tightly coupled to a CPU in order to gain the maximum efficiency, it is not easy to extend the DMA model to cover systems with multiple CPUs. In particular, the extension of the DMA model to multiple CPUs incurs further programmer burden in the form of resource locking and consistency.
4. The DMA model becomes rather unwieldy for processing tasks involving the handling of a large number of relatively small structures. The comparatively high overhead associated with setting up and managing DMA transfers limits their scope to large data blocks, as the overhead of performing DMA transfers on many small data blocks would be prohibitive. Unfortunately, packet processing workloads are characterized by the need to access many small data blocks per packet; for instance, a typical packet processing scenario might require access to 8-12 different data structures per packet, with an average data structure size of only about 16 bytes. This greatly limits the improvement possible by using standard DMA techniques for packet processing.
5. A particularly onerous problem is caused when a small portion of a data structure needs to be modified for every packet processed. For instance, updating a statistics counter on a per-packet basis using a standard DMA approach requires three individual operations—a DMA transfer to read the counter value from memory, software to increment the value, and another DMA transfer to write the new value back to memory. The amount of overhead is very large in proportion to the actual work of incrementing the counter.

Two different mixed approaches are considered to exemplify the general nature of the prior art systems. These approaches are direct-deposit caches and software-controlled prefetch.

Direct Deposit caches

A relatively recent technique, implemented in some embedded CPUs aimed at packet processing applications, allows a DMA controller to be set up to directly push data into an otherwise standard cache associated with a CPU. Essentially, the DMA controller is modified to transfer data under software control between an I/O device and a first-level or second-level CPU cache. This permits the DMA controller to be set up in the normal fashion, but with reduced overhead incurred by the CPU when accessing the packet data. Note that the cache is also expected to perform its normal functions in support of general-purpose software running on the CPU. However, direct deposit caching techniques suffer from the following disadvantages:
1. Possibility of pollution/collisions when the CPU falls behind. If a simple programming model is to be maintained, then the direct deposit technique can unfortunately result in the overwriting of cache memory regions that are presently in use by the CPU, in turn causing extra overhead due to unnecessary re-fetching of overwritten data from the main memory. This effect is exacerbated when pathological traffic patterns result in the CPU being temporarily unable to keep up with incoming packet streams, increasing the likelihood that the DMA controller will overwrite some needed area of the cache. Careful software design can sometimes mitigate this problem, but greatly increases the complexity of the programmer's task.
2. Results in non-deterministic performance; as a hardware-managed cache is being filled by the DMA controller, it is not always possible to predict whether a given piece of data will be present in the cache or not. This is made worse due to the susceptibility to pathological traffic patterns as noted above.
3. Only packet access is improved. The CPU usually needs fast access to more than packets in packet processing systems. For instance the address tables used to dispatch packets are typically very large and incapable of being held in the cache. As a result, this technique only offers a partial solution to the problem.
4. Does not take advantage of programmer's knowledge of data locality. As mentioned previously, it is highly desirable to enable the system to utilize the programmer's a priori knowledge of the optimum data access patterns required for different packet processing tasks. The direct deposit technique does not facilitate this.
5. Limited utility for multiprocessing; as a DMA controller is autonomously depositing packet data into a cache, it is difficult to set up a system whereby the incoming workload is shared equally between multiple CPUs.
   Software-Controlled Prefetch

Some CPUs have implemented special facilities (usually controlled by specialized CPU instructions) that permit the programmer to specify when particular blocks of data must be fetched from main memory into the cache, or stored from cache to main memory. These techniques are grouped under the term software-controlled prefetch. The intent of the technique is to place the burden of optimizing access to the data needed to process packets directly on the programmer, using the standard CPU cache as a scratchpad memory to hold the data being processed. Further, standard means of denoting cacheable and uncacheable data regions in memory can be used to allow a single cache system to support software-controlled prefetch data as well as normally fetched and cached data.

This technique has been beneficial in packet processing applications as it enables complete control of the memory accesses needed for processing each individual packet. The same technique supports both accesses to packet data as well as to the data structures required to support the processing of the packets. Finally, the semantics of the prefetch commands can be made nearly identical to those of the normal load and store instructions of the CPU, greatly reducing the programmer burden. Software-controlled prefetch techniques, however, suffer from the following issues:
1. They become hard to manage as the number of data structures grows; the programmer is often forced to make undesirable tradeoffs between the use of the cache and the use of the prefetch, especially when the amount of data being prefetched is a significant fraction of the (usually limited) cache size. Further, they are very difficult to extend to systems with multiple CPUs.
2. It is difficult to completely hide the memory latency without incurring significant software overhead; as the CPU is required to issue the prefetch instructions, and then wait until the prefetch completes before attempting to access the data, there are many situations where the CPU is unavoidably forced to waste at least some portion of the memory latency delay. This results in a loss of performance.
3. Statistical gain rather than deterministic gain. Software-controlled prefetch techniques operate in conjunction with a cache, and hence are subject to similar invalidation and pollution problems. In particular, extension of the software-controlled prefetch method to support multi-threaded programming paradigms can yield highly non-deterministic results.

A need continues to exist for a packet processor that overcomes the above shortcomings, has enhanced memory utilization, and supports multi-threading.

### BRIEF SUMMARY OF THE INVENTION

A DMA engine, in accordance with one embodiment of the present invention, includes, in part, a DMA controller, an associative memory buffer, a memory interface, a request First-In-First-Out (FIFO) buffer, and a response FIFO buffer.

The request FIFO accepts data transfer requests from a programmable engine such as a CPU. The response FIFO returns the completion status of these data transfer requests to the programmable engine. Each request includes, in part, a target external memory address from which data is to be loaded, or to which data is to be stored; a block size, specifying the amount of data to be transferred; and context information for later use by the software. Each response includes the context information that was provided as part of the corresponding request, and is placed into the response FIFO after the request has been processed and completed.

The associative buffer holds data fetched from the external memory, and provides the data to the requesters (e.g. CPUs) for processing. Loading into and storing from the associative buffer is done under the control of the DMA controller. When a request to fetch data from the external memory is processed, the DMA controller allocates a block within the associative buffer to hold the fetched data. When the external memory responds with the requested data, the DMA controller causes the data to be loaded into the allocated block. The DMA controller moves the context information for this data to the Response FIFO. The requester reads response context from the response FIFO and can then access the fetched data by simply reading or writing to the given external memory address. The associative buffer automatically traps the read or write accesses and directs them to the appropriate block within itself, providing the read data and accepting the write data. After the requester has finished processing the fetched data, it generates a retire request to the DMA controller, which in turn, causes the modified data within the associative buffer to be written out to the external memory, and the allocated space within the associative buffer to be freed for future use.

The DMA engine of present invention may be used, for example, in data processing situations when a software-programmable element such as a CPU is required to process data that is organized in relatively small blocks of varying sizes, with the blocks being stored in a memory having a long latency, and the blocks are not distributed in a uniform or regular manner through the memory. These situations commonly occur when performing packet processing, wherein one or more networking protocols must be implemented efficiently in order to process incoming or outgoing packets at the desired rates. Another example of such a situation is searching and sorting within very large data sets comprising small records or blocks of data.

A DMA engine, in accordance with the present invention, achieves determinism and uniformity in operation. The DMA engine has a predictable performance gain, given a specific packet processing workload and thus avoids statistical performance. It also avoids large variations in processing delay from packet to packet, that would otherwise cause excessive buffering needs and also excessive worst-case end-to-end latencies. The DMA engine of the present invention requires minimal software bookkeeping overhead. It provides relatively significant amount of software transparency in order to eliminate the need for a programmer to understand and deal with the limitations of the underlying hardware.

Data fetch/retire operations are substantially under programmer control, so that software can optimize memory access behavior to use memory bandwidth most efficiently. In most packet processing situations, the programmer is well aware of the memory access patterns required, and can specify the most optimal use of memory bandwidth. Furthermore, because the present invention is less resource intensive than a standard cache hierarchy, it has a substantially reduced complexity, and avoids complex and specialized programming models.

A DMA engine, in accordance with the present invention, maintains efficiency and is capable of tolerating very large memory access delays. The DMA engine is further configured to provide performance gains for different types of data structure accesses, in addition to packets.

### BRIEF DESCRIPTION OF THE DRAWINGS

FIG. 1 is a simplified high-level block diagram of a DMA engine, in accordance with one embodiment of the present invention.

FIG. 2 is a block diagram of DMA engine, in accordance with another embodiment of the present invention.

FIG. 3 shows a basis for the sizing of the associative buffer in packet processing applications, in accordance with another embodiment of the present invention.

FIG. 4 shows a general purpose multi-port protocol processor embodying a DMA engine, in accordance with the present invention, and adapted to handle a multitude of networking protocols and functions.

FIG. 5 is a high level block diagram of a programmable engine embodying a DMA engine, in accordance with another embodiment of the present invention,

### DETAILED DESCRIPTION OF THE INVENTION

In accordance with one embodiment of the present invention, the throughput of a programmable system employing CPUs (or other programmable engines that have similar characteristics), is deterministically enhanced, particularly, when applied to the processing of packets at high speeds. The effects of high memory latency relative to the processing rates of these programmable engines is mitigated. The invention may be applied to any CPU architecture, and enable such a CPU to support a large variety of packet processing functions in software with high efficiency. The data paths are enhanced using the known characteristics of packet processing functions, along with some degree of software involvement in optimizing the memory access patterns.

The DMA engine disclosed herein represents a relatively simple yet highly capable variation on both a traditional cache and a traditional DMA subsystem. It can be advantageously applied to a variety of protocol processing applications, as it has the generality of a cache (which is transparent to the data being processed) but the efficiency of a DMA controller (which is typically obtained by means of specialized hardware adapted to a particular protocol or processing algorithm). Due to its simplicity, it is also capable of being applied to high-speed packet processing systems, where more complex DMA elements may not be usable. Further, it avoids the hardware-intensive nature of caches, which is a consequence of the cache's need to guess the data to be fetched or stored. As the software is directly involved in the fetch/store decisions, the hardware can be considerably reduced without loss of performance.

One advantage of the DMA engine of the present invention compared to conventional systems is its ability to function efficiently when dealing with a wide variety of data structures, access patterns, and programming models. For instance, lower-level protocol processing (such as Layer 2 or Layer 1 processing) demands that relatively small pieces of data be fetched frequently. This type of processing is unsuited to cache structures, which function better with larger data structures possessing higher locality. On the other hand, higher-level protocol processing (e.g., TCP/IP) entails handling larger chunks of data that have high locality, but need to be extensively modified and resized. This is not well handled by traditional DMA systems, that are better at data copying than data modification and buffer resizing. The DMA engine of the present invention includes the combined features of a fully-associative cache and a DMA controller, and can be used efficiently in both situations. Thus the DMA controller engine of the present invention is easily applied to devices or products which are required to handle a variety of different protocol processing functions efficiently. Examples of such product areas are network processors, protocol accelerators, and network switching elements.

A further advantage of the DMA engine of the present invention compared to conventional systems is its ability to support a low-overhead simultaneous multi-threading model on one or more conventional CPUs without hardware-based context switching capability, in a network processing environment. The context required by each thread of execution is passed back and forth between the DMA engine and the CPU(s) via the request and response queues, with the data required by each thread being guaranteed to be available to the thread when it is made ready to run. This results in the simplicity of programming and high tolerance to memory latency of simultaneous multi-threading systems without the substantial increase in hardware cost and complexity.

Another advantage of the DMA engine of the present invention compared to conventional systems is its ability to efficiently and transparently load-share a given workload over multiple CPUs in a networking environment. In a system with multiple CPUs, all idle CPUs will constantly poll the response queue of the DMA engine of the present invention for work to be performed. The first CPU to receive an item from the response queue will become busy, while the remainder will continue to poll. The workload hence self-balances over all of the available CPUS. It is not necessary for any CPU to explicitly pass an item of work to another, or to perform load-balancing operations. Further, packet and other data required to complete a task are automatically passed from one CPU to another without requiring explicit programmer intervention.

Yet another advantage of the DMA engine of the present invention compared to conventional systems is its ability to simplify interaction between software (on the CPU(s)) and hardware. In a multi-CPU system that also includes hardware elements such as switch fabric interfaces and MAC logic, it is necessary to pass data items between CPUs and between a CPU and a hardware element. Caching such data items results in a high overhead due to the need to maintain cache consistency; not caching such data items has heretofore implied a significant performance loss. The DMA engine of the present invention enables the benefits of caching to be obtained without losing the simplicity and determinism of direct memory reads and writes.

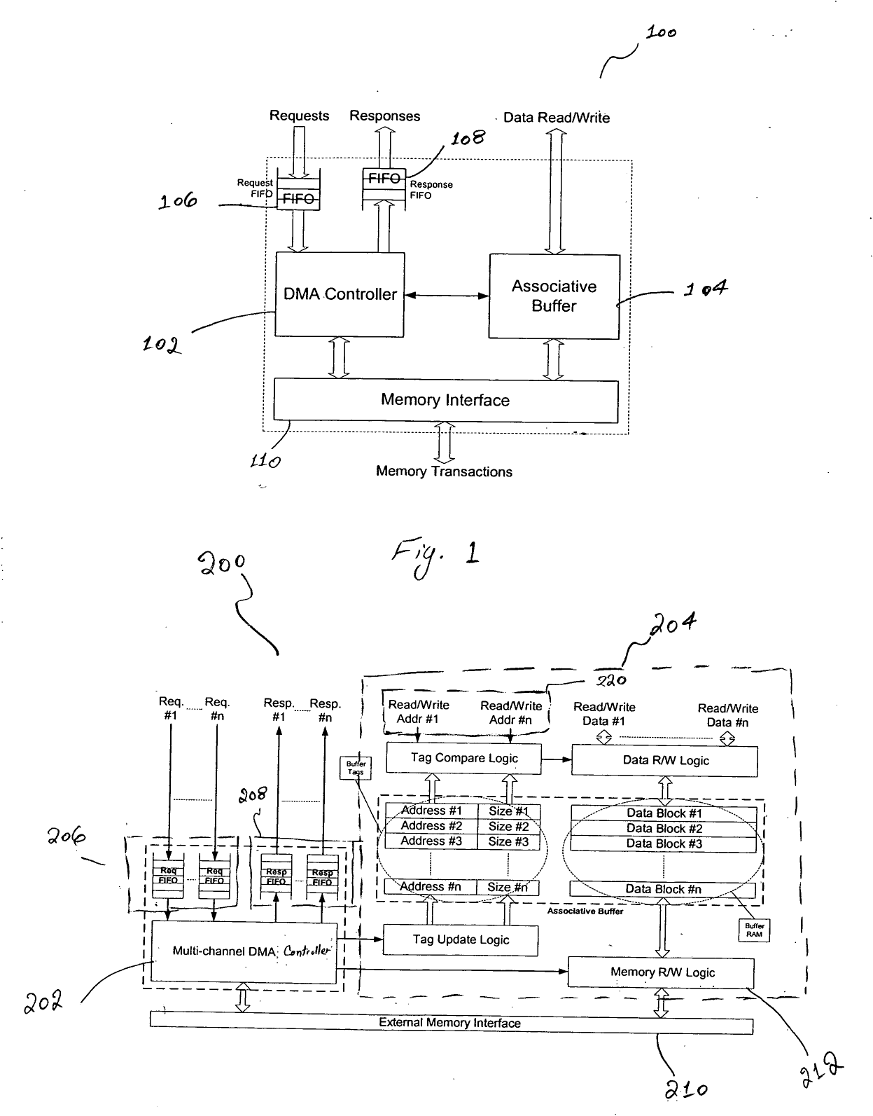

FIG. 1 is a simplified high-level block diagram of a DMA engine 100, in accordance with one embodiment of the present invention. DMA engine 100 is shown as including a DMA controller 102, an associative memory buffer 104, a memory interface 110 configured to enable data to be transferred between an external memory (not shown) and the associative buffer, a request First-In-First-Out (FIFO) 106, and a response FIFO 108.

The request FIFO 106 accepts data transfer requests from a programmable engine such as a CPU, while the response FIFO 108 returns the completion status of these data transfer requests to the programmable engine. Each request includes, in part, a target external memory address from which data is to be loaded, or to which data is to be stored; a block size, specifying the amount of data to be transferred; and context information for later use by the software. Each response includes the context information that was provided as part of the corresponding request, and is placed into the response FIFO 108 after the request has been processed and completed.

The associative buffer 104 is used to hold data fetched from the external memory, and provide the data to the requesters for processing. Loading into and storing from the associative buffer 104 is done under the control of the DMA controller 102. When a request to fetch data from the external memory is processed, the DMA controller 102 allocates a block within the associative buffer 104 to hold the fetched data. When the external memory responds with the requested data, the DMA controller 102 causes it to be loaded into the allocated block and associated with the external memory address of the data. The DMA controller 102 moves the context information for this data to the Response FIFO 108. The requester, such as a CPU, reads response context from the response FIFO 108 and can then access the fetched data by simply reading or writing to the given external memory address; the associative buffer 104 automatically traps the read or write accesses and directs them to the appropriate block within itself, providing the read data and accepting the write data.

After the requester has finished processing the fetched data, it generates a retire request to the DMA controller 102, which in turn, causes the modified data within the associative buffer 104 to be written out to the external memory, and the allocated space within the associative buffer to be freed for future use.

The memory interface 110 serves to interface the system to the desired external memory subsystem. It accepts read and write requests from the DMA controller 102, and, in response, transfers data between the associative buffer 104 and the external memory. Memory interface 110 is well known and is not described.

Associative data buffer 104 together with DMA controller 102, in accordance with the present invention, greatly simplify the programming model over that of a conventional DMA coupled to a scratchpad memory. In the latter case, the programmer would be tasked with mapping specific memory blocks within the scratchpad to specific data structures, and handling the bookkeeping (allocation and deallocation) needed. The fully associative data buffer 104, however, completely eliminates all this overhead.

The request/response model offers significant benefit over standard cache prefetching or flushing mechanisms, in that the programmer has a positive, non-blocking indication of when the requested transaction is completed. In a cache prefetch mechanism, on the other hand, the only facility available to the programmer to determine when the prefetch has completed (beyond directly scanning the tags) is to make a fetch to the target data. If the fetch is made too soon, then it will block and CPU time will be lost. The request/response paradigm, however, enables the efficiency of an interrupt-driven model to be achieved, without the burden of a conventional DMA. In addition, as is described later, this is particularly suitable for implementing context swapping programming models on a single-threaded CPU. The request/response paradigm is also useful for hardware multithreaded CPUs.

The explicit writeback of data is much more deterministic than a standard cache. In a conventional cache, a cache miss will usually cause a line of data to be replaced by new data. Other than explicitly locking selected pieces of data into the cache, the programmer has no control or knowledge of which line is replaced. This causes non-deterministic behavior and possibly even thrashing. The explicit writeback allows the programmer to ensure that data is held in the associative buffer for exactly as long as it is needed.

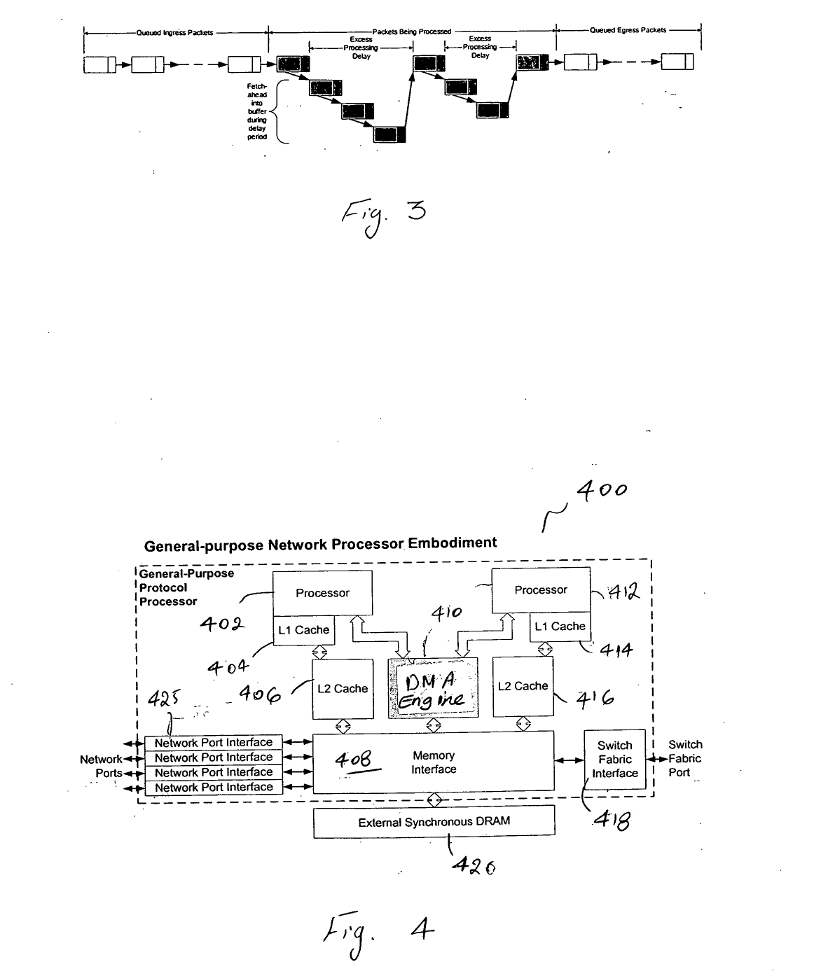

FIG. 2 is a block diagram of DMA engine 200, in accordance with another embodiment of the present invention. DMA engine is configured to support up to n requesters of memory bandwidth, where n is an integer greater than 1. Each requester may be a CPU or any other type of programmable functional unit that requires access to the data stored in the memory. Fixed-function units, in addition to programmable units, may be included among the requesters of memory bandwidth. In fact, this may be desirable in circumstances where the fixed-function units share the same data structures as the programmable units.

As shown in FIG. 2, DMA engine 200 is shown as including a multi-channel DMA controller 202, an associative buffer 204 with logic used to connect it to the external memory interface 210, and a multi-ported requester interface 220 into the associative buffer.

As shown in FIG. 2, the multi-channel DMA controller 202 is coupled to a set of request queues 206 and a set of response queues 208. The request queues accept multiple data fetch or data store request messages from multiple requesters, and buffer these requests for processing by the DMA engine. Each request queue is built around a standard FIFO buffer, and can hold the data belonging to one or more request messages. Use of the FIFO must be managed by software; however, a stall mechanism may be constructed to handle software errors.

A request message consists of a starting address, i.e., a location in the external memory), a transfer size in terms of some units, such as bytes or words, a command (e.g., whether to fetch or store data), and some context. For requests larger than the associative buffer block size, software must make multiple requests. The size of the context is dependent on the specific implementation. The context allows the implementer to uniquely tag or identify each request, and subsequently correlate them to the returned responses. The context information may also be used by the requester to perform other implementation-specific functions.

A data fetch request is processed by allocating an entry in the associative buffer 204 and then issuing a data read command to the external memory. The memory read transactions are linked to the requests—by methods well understood by those skilled in the art—such that when data are received from the external memory, they are placed into the proper location within the associative buffer. The DMA engine will also deem the request to have been processed at this time. If no block is available in the associative buffer 204, the DMA engine simply stops processing data fetch requests until a data store request has been processed. The size of the associative buffer is hence workload-dependent, and should be fixed appropriately. A data store request is processed in a similar manner, by locating the entry in the associative buffer that contains the data to be stored, and then transferring the data to the proper location in the external memory. Similarly, when the data has been completely transferred to external memory, the DMA will denote the store request as having been processed.

The completion of processing of each request, i.e., the completion of the requested data transfer, results in a response that is placed in one of the response queues. The response may be any information that is deemed necessary by the implementation, such as the address of the data just transferred, the context data, some internal tag information, etc. In the preferred embodiment, the response data includes the context information; as the originator of the request provides this context information, it can be formatted and organized in the most convenient manner according to the requirements of the requester, and independently of the internal working of the DMA controller 202.

The number of response queues may or may not be equal to the number of request queues. For instance, one embodiment may provide less response queues than request queues. In one embodiment, there are N request queues (where N is the number of requesters) but only one response queue. All responses are placed in this single response queue, regardless of the sources of the requests; the programmable entities gain access to the response queue in turn and obtain the contexts from the completed responses in order to determine the next piece of work that must be done, as described more fully below.

Associative Buffer

The associative buffer includes a small, fully-associative cache memory; it does not include a cache hit/miss and fill logic. The associative buffer contains a small number of data blocks (e.g., 16-128 blocks), organized as logical partitions of a single buffer RAM. Each block can hold some maximum amount of data, corresponding to the specific requirements of the application. For networking applications, 64 bytes is a typical amount of data that must be held by a single block.

Each block is further associated with a base address and a size value (collectively referred to as a tag) that indicates the amount of data that has been transferred into the block from the main memory. The normal associative address comparison method (well known in the prior art) is utilized to search the tags of the blocks in parallel, to determine which block contains some desired piece of data. The set of base addresses and sizes are denoted as the buffer tags in FIG. 2.

Data is placed into the associative buffer when it is fetched from the external memory under control of the DMA engine. As described above, the DMA controller 202 causes a free block within the associative buffer to be allocated, and then instructs the external memory to return the requested data. As the data arrives, the memory read/write logic 212 places the data into the proper block. When all of the data has been fetched, the tag associated with the block is updated to reflect the starting external memory address and the number of units of data within the block. After the tag has been properly updated, the requesters may read and write the fetched data by accessing the associative memory. The associative buffer effectively implements a write-back strategy; no data are written to main memory until the block is explicitly written out using a programmer-generated request.

Data is likewise transferred from the associative buffer to the main memory under DMA control and, in turn, under the control of the requesters. The DMA controller 202 locates the block within the associative memory that contains the data to be transferred, and then instructs the external memory interface to begin the transfer. The associative buffer then passes the actual data to the external memory interface (when the latter is ready to accept it), which subsequently writes the data to the external memory. When all of the data have been transferred, the tag associated with that block is invalidated by setting the size value to zero thus indicating an empty block. The block is now considered to have been freed, and may be re-used for holding other data in the future.

The primary purpose of including a size with each tag is to account for the fact that the data structures used during packet processing vary in size, and are usually packed adjacent to each other. If a complete 64-byte block of data were fetched into the buffer, irrespective of the actual size of the underlying data structure, then it is likely that multiple adjacent data structures would be consequently placed into one block of the buffer. This can cause serious issues when writing back a modified data structure.

As a specific example, assume that each entry in an array of statistics counters consumes 16 bytes. When a CPU needs to update a statistics entry, it issues a fetch request for the 16 bytes, receives the response, updates the necessary statistics counter(s), and then issues a store request for that specific entry. In the mean time, another CPU might need to update the immediately adjacent statistics entry at the same time (and would therefore issue its own fetch and store requests). If the associative buffer fetched a full 64-byte block worth of data every time, however, multiple statistics counter entries would be read into a single block; the writeback of a block by the first CPU could potentially overwrite the adjacent statistics entry being operated on by the second CPU. To avoid this hazard, the CPUs need to specify the exact number of bytes in the data structure being fetched, and the associative buffer should only hold that number of bytes. There is no performance improvement implied by fetching less data. In modern memory systems with wide data buses, transferring less data may not necessarily result in a reduction in transfer time.

This behavior also simplifies the transfer of data structures between software and hardware. In traditional cache systems, data structures that are shared between software and hardware impose additional overhead to maintain consistency, caused in part by the lack of correlation between the width of a cache line and the width of the data structure. As the associative buffer effectively has a variable-width cache line that is aligned and sized to the target data structure, these consistency issues are avoided. The software also has explicit guarantees of memory consistency, indicated by the response to a store request.

Multi-Ported Requester Interface Into Associative Buffer

The multi-ported requester interface serves to couple the CPUs or other programmable elements (i.e., the requesters) to the associative buffer. Each requester may make a read or write access at any time to the data in the associative buffer. The multi-ported interface accepts these accesses, which may potentially be made concurrently if there are multiple requesters, looks up the data in the buffer, and returns the accessed data in the case of a read request, or updates the accessed data in the case of a write request. It thus ensures that conflicts or collisions do not occur when making the actual accesses to the buffer.

Additionally, the requester interface maps between the addresses of the target data that are provided by the requesters, and the specific blocks containing the accessed data within the associative buffer. Each requester accesses data using the address of the data in the external memory; requesters are freed from the burden of having to determine which specific associative buffer block contains the target data. The requester interface accepts these addresses and performs an associative compare over all of the tags to determine the specific block and the offset within the block that actually contains the data. This is then used to return or update the requested data.

It is considered to be an error if the requester interface is given a request for a piece of data that is not present in the associative buffer. All data in the associative buffer is expected to have been fetched under program control, and hence an attempted access to a missing piece of data should not occur under normal operation. If such an access does occur, some implementation specific action should be taken to notify the requester (or the system) that a catastrophic error has occurred. In the preferred embodiment, an interrupt is generated to the CPU making the errored request, to allow it to invoke software handling procedures to localize the fault and terminate processing. Both address and size checks are made in order to determine whether data is present or missing. There is some extra hardware penalty for this function (as opposed to a conventional cache, where the lines are sized and located on convenient powers-of-2 boundaries), but this is minor.

Programming Model and Operation

The general programming model used with the DMA controller is relatively straightforward. The various requesters generate data fetch requests to the DMA controller, instructing it to fetch the data from the external memory and place it into the associative buffer. Once the data is present in the associative buffer, the DMA controller returns a response indicating that the data may be accessed at will. The requesters then perform standard read and write accesses to the data, using the same addressing scheme that would have been employed had the accesses been made directly to the external memory. When the requesters have completed their processing tasks on the fetched data, it may be written to the external memory by a subsequent request to the DMA engine. As the associative buffer contains a number of blocks for holding data, multiple requesters may fetch and process multiple pieces of data concurrently.

In one embodiment, a further improvement that employs the well-understood technique of multi-threading is possible, and makes the programming model even more efficient and simple. The improvement is particularly significant in that it enables multi-threading to be implemented using single-threaded CPUs, avoiding the complex stall detection and context swapping hardware that would otherwise be necessary. This is done by utilizing the context information—passed to the DMA controller in the request, and returned from the DMA controller in the response—to effectively drive a context switching scheme between multiple concurrent threads of execution operating on multiple CPUs in parallel. Further, in a system with N CPUs, there are N request queues but only one response queue. With such an arrangement, the following programming model is achieved when using the DMA engine of the present invention:
1. An incoming packet is received and placed into the external memory. The packet receiver triggers execution of the initial processing functions by some standard means such as an interrupt. This processing function executes as the first thread of control on one of the CPUs in the system.
2. The CPU execution thread generates a fetch request to the DMA to fetch the first block of data from the packet. The context information supplied along with the request contains an identifier that uniquely identifies the packet (e.g., the starting address of the packet in memory) plus another identifier that indicates the next processing step to be performed (e.g., an index into a jump table pointing to processing routines). The thread then completes, and returns to a software thread dispatcher that polls the DMA response queue waiting for the next task to be performed. The mechanisms of thread switching are well understood and not germane to the present invention. It is only necessary that the CPU be permitted to switch, in software, to some other thread of execution while waiting for the requested data block to be returned by the DMA.
3. The DMA thereupon processes the request; it allocates a free block, fetches data into it, and sets the block tag appropriately. When the request has been completely processed, the context associated with the request is placed in the response queue.
4. The presence of returned context information within the response queue triggers a CPU to read the data out of the response queue. This may be any of the CPUs in the system. The CPU will fetch the context information from the response queue, parse the identifier of the processing step to determine what processing function to perform, and utilize the identifier of the packet to determine what packet data to perform the processing on.
5. The CPU then processes the data in the packet. As the relevant packet data have been fetched into the associative buffer, the thread of execution simply performs reads and writes to the packet's external memory address; these will automatically hit in the associative buffer, resulting in zero delays waiting for the external memory to respond.
6. At some point, it may become necessary to fetch additional data (e.g., an address table entry pertaining to the packet) from external memory in order to continue with packet processing. The CPU then generates a new fetch request to the DMA, identifying the data to be fetched and also providing context information. In the same manner as before, the context information contains a packet identifier and another next-step identifier. After the fetch request is made, the thread completes and the CPU either switches to another thread or goes to sleep, depending on whether the response queue is empty.
7. When the DMA completes fetching the requested data, as before, it places the context into the response FIFO. A new CPU may now pick up this context and initiate another thread of execution that continues packet processing. Again, the wait for the external memory to respond does not impact the efficiency of the CPUs; while the data fetch is proceeding, the CPUs in the system are free to continue working on other packets or other tasks. The context information contains the necessary data structure pointers and function identifiers that must be passed from CPU to CPU (without requiring additional memory accesses) to enable any CPU to take up packet processing at the point where a previous CPU had to stop in order to make a memory access.
8. The process outlined above can be continued until the packet is fully processed and ready to be written back to the external memory. When the last thread finishes processing the packet, a store request is sent to DMA via its request queue. The DMA then writes out the data in the associative buffer to the external memory, and retires the block within the buffer to make it available for subsequent packets. If any additional data structures, such as address table entries, were fetched during the course of processing the packet, they should also have been freed by this time. At this point, the packet is fully processed; the context returned from the store operation can be passed to some hardware entity that sends the packet on to its next recipient.

It is clear that in the process outlined above, the CPU is not required to waste time waiting for a memory operation to be performed unless there is no additional work to be performed in terms of new packets arriving to be processed, in which case the waste of time is unavoidable and of no consequence. Thus the software multi-threading driven by the response queue of the DMA engine of the present invention provides a general-purpose system that can perform network processing tasks with very little performance loss due to memory latency, without having to resort to special-purpose hardware.

In certain applications, it may be necessary to allow multiple CPUs, or threads on a CPU, to access the same data structure for read-only purposes, or to access different parts of the same data structure for read/write purposes. The read-only access is clearly simple to solve—each CPU makes an independent request for the data, and the DMA engine of the present invention either fetches the same data multiple times, or optimizes by fetching once and then responding multiple times. A reservation mechanism of some kind should, of course, be provided to ensure that data is retired only when the last CPU or thread has completed its processing.

The read/write access, however, requires special care to avoid data consistency problems. This can be handled in one of two ways. One way is to use traditional programmer-managed semaphores and spin locks to serialize access to the shared data structure. This is well known in the prior art and is not described herein. Another way is to break up the data structure into sub-structures, each of which is separately fetched by the DMA of the present invention in response to separate requests. Thus a CPU wishing to modify one part of a data structure will issue a request for only the portion it needs to change. Programmers will, of course, still need to take care to prevent two CPUs from accessing the same portion of a data structure simultaneously. This should be easily solved by proper partitioning of the processing tasks and ensuring that potentially conflicting tasks are appropriately serialized. In the case of a single multi-threaded processor, atomicity may also be ensured by performing the read-modify-write between context swaps.

Context Swapping Support

As previously mentioned, the DMA of the present invention, as shown in FIGS. 2 and 3, lends itself very well to the context swapping operations required to support a multi-threading system. The ability of the DMA to accept and return an arbitrary piece of context relieves the CPUs in the system of the need to maintain state information relating to the thread context (so that threads may be properly resumed when they are ready to run again). This, in turn, results in a very efficient multi-threading system. There is little or no push of thread state to an in-memory stack when a thread switch occurs. There is no need to select the next thread to be run—this is automatically done by reading the response queue. There is no need to restore thread state prior to starting again.

The amount of context to be passed between the CPUs and the DMA of the present invention is dependent on the requirements of the application. For typical networking applications, no more than 32 or 64 bits of context information may be required, as most of the information to be processed by the thread is contained within the packets, or the data structures associated with the packet processing such as address tables and arrays of counters. Enhancements to the basic augmented DMA concept, as will be discussed later, may entail additional context information to be handled.

Optimizing Buffer Retirement

In a traditional set-associative or direct-mapped cache structure, a given region of memory can only be placed in a subset of the cache, i.e., a certain set of cache lines. Thus, when this subset is fully occupied with existing data, bringing in new data necessitates first writing back some of the existing data to the external memory to make room. Thus the process of reallocating a cache line can take considerable amount of time due to the need to wait for the external memory to accept the data being written back. Write buffers are hence used in traditional caches to facilitate the process of writing back data from a cache line to external memory. They allow the cache to copy the data out of a cache line that is being re-allocated into the (high-speed) write buffer, thus freeing up the cache line for immediate use by the CPU without having to wait for the external memory to respond to the write transaction. The data are then subsequently transferred out of the write buffer into the external memory. All of this entails some fairly complex logic.

In accordance with the DMA engine of the present invention, a fully-associative buffer is used, and any block in the buffer can hold data from any target memory address. Thus no write buffer is necessary. Instead, the DMA engine maintains a list of blocks in the associative buffer that are to be retired, i.e., written to memory. As each entry on such a list is written to the external memory, it can be removed from the list and returned as a free list for re-use. If, in the mean time, a new block of data must be fetched, this can be done independently into any available free block in the associative buffer, without having to wait for some specific block on the retire list to be freed.

Sizing of Associative Buffer

The minimum size of the associative buffer is determined primarily by the requirements of the application, but may be easily computed if some characteristics of the application are known. This computation is performed as follows. The size of each block in the buffer, referred to herein as B, is determined by the largest data structure that must be processed as a single unit by the system. For typical networking applications, B is on the order of 32 or 64 bytes. The number of blocks in the buffer, referred to as N, is determined by the worst-case processing latency caused by unpredictable delays such as memory accesses. The number of blocks needs to be only large enough to absorb the maximum latency variation experienced due to memory access, so that the CPU can continue to process data without interruption while the DMA is fetching or storing information to the external memory. Typically, N ranges from 32 to 128 blocks. The total size of the associative buffer is therefore equal to B*N bytes.

The block size and the number of blocks is independent of the number of queued packets, the system throughput, algorithm, and so on. This is in contrast to special-purpose hardware accelerators, which must be carefully tailored to their specific tasks. FIG. 3 illustrates the basis for the sizing of the associative buffer in packet processing applications.

To consider an example of a typical associative buffer size computation, assume a I Gb/s Ethernet stream, a 500 MHz CPU, a 300 clock (300 instruction) sustained execution time per packet, a 500 clock worst-case execution time per packet (due to memory latency variation), and a 100-packet worst-case burst. When computing the capacity of the associative buffer according to the rules presented above, N is calculated as equivalent to about 50 packets worth of storage. With a B of 64 bytes, the total buffer size required is at least 3200 bytes. This is very small in comparison to typical sizes of modern cache structures.

A DMA engine, in accordance with the present invention provides a number of advantages when used in networking applications. First, much less software bookkeeping overhead is required than conventional DMA controllers. Standard DMA controllers used for packet processing generally require the programmer to allocate and manage a copy buffer into which data from the external memory is placed, and from which data is copied to the external memory. The DMA engine of the present invention, however, does not require a copy buffer. The associative buffer acts in a similar manner to hardware-managed caches, that are transparent to the software. There is also no need to create software structures in order to pass context between threads, as the DMA engine of the present invention automatically handles this issue.

Second, fetching data from the external memory, and retiring (writing-back) of data to the external memory, is entirely under the control of the programmer. This permits the programmer to utilize a priori knowledge of the access patterns of the algorithm being executed on the CPU in order to optimize the memory access behavior, in turn leading to deterministic gain, rather than the statistical gain obtained from traditional cache prefetch and writeback hardware. As an example of why cache prefetch results in statistical gain, consider that a prefetch causes a line to be purged from the cache, but the programmer does not have any control over what line specifically is purged. The prefetch could therefore purge a line that might still be in active use. In addition, the fetch and writeback are fully non-blocking (i.e., they do not stall the CPU while waiting for the external memory to complete a transaction), leading to further deterministic processing gain. Finally, the DMA of the present invention is not susceptible to pathological packet arrival patterns (e.g., a long stream of back-to-back packets that exercise the worst-case execution paths through the CPU), unlike a traditional cache that can be quickly overwhelmed by pathological patterns that result in cache thrashing.

Third, the present invention is much less resource intensive than a modem cache. Modem cache structures are quite complex, as they attempt to perform a large number of memory access optimizations in hardware. In addition, they tend to become more complex as the processing rates rise relative to the intrinsic speed of the implementation technology. The DMA of the present invention avoids all of these issues. For instance, hits in the associative buffer are guaranteed by system architecture and software coding, and there is only the need to detect and flag catastrophic coding errors resulting in misses. There is also no inter-CPU coherency logic (snooping, invalidation, etc., according to the various cache coherency protocols).

Fourth, very simple programming model is required for a multi-threaded environment. The response FIFO can be used to easily support a multi-threaded programming model, as it contains the returned context from the DMA fetches and stores. As already discussed, the context can automatically drive thread switches without losing efficiency or requiring complex hardware simultaneous multi-threading support.

The combination of thread-switching and the DMA of the present invention can be employed to hide virtually any amount of memory access delays, provided that the associative buffer is large enough and the CPU has enough work (in the form of incoming packets) to do. This contrasts with the various types of software-controlled prefetch techniques, which break down when some limit of memory access latency has been reached, as a consequence of the lack of feedback from the memory subsystem to the programmer as to when the requested data are available.

In accordance with some embodiments of the present invention, the DMA engine maintains a state table showing the data structure size to be fetched or stored to each different region of memory. Typical software programs divide their address spaces into regions, with each individual region containing only one type of data structure. Thus, for instance, one region may be allocated to hold address tables, another region may hold counter blocks, yet another may hold hash tables, and so on. If a structure similar to a standard Translation Lookaside Buffer (TLB) were to be used in conjunction with the DMA engine of the present invention to map regions of memory to the sizes of data structures that they contain, then the software would be freed from the burden of specifying a size every time it requested the augmented DMA to transfer the data structure. A fetch or store would then simply consist of an address and context, and the augmented DMA could automatically infer and fetch or store the required amount of data.

In accordance with some embodiments of the present invention, the DMA engine is configured to check the associative buffer before fetching data into it, to verify whether the associative buffer already contains the requested data. This is of significant utility in a multi-CPU or multi-threaded system, where different CPUs may request access at different times to the same unit of data (e.g., a packet being passed from CPU to CPU during processing). If the requested data structure is already in the associative buffer, then the DMA engine could avoid fetching it from external memory, and instead immediately return the necessary response. This allows multiple CPUs, implementing chained processing tasks in a pipeline on the same workload, to pass data structures around with low overhead, without losing the deterministic gain visible to the programmer. This assumes that the programmer has a-priori knowledge of the existence of the data within the associative buffer. Thus, the extra burden of programmatically specifying in the request that the data is already present in the associative buffer is avoided.

Under certain circumstances, there is no need to fetch data from the external memory when allocating a block within the associative memory. This occurs, for instance, when the software is attempting to allocate a memory region into which a packet to be transmitted will be generated. In this case, attempting to fetch the corresponding region of data from the external memory represents wasted time and memory bandwidth, as none of the fetched data will be used; it will be completely overwritten by the software. A traditional cache cannot detect this situation, (caches must always keep their allocated cache lines consistent with memory) and hence will incur unnecessary overhead. The DMA engine of the present invention, however, can easily handle such cases by implementing a special fetch request type that will be used by the software whenever such allocation without fetch is to be performed. The special request type can be interpreted by the DMA engine and the otherwise wasted memory read operation is thus avoided.

The DMA engine, in accordance with some embodiments, may be configured to support a locked fetch request types. In the event of a read-modify-write to a shared data structure, such as a block of counters that are to be updated on each packet, it is necessary to ensure that only one CPU at a time has access to a given region within the shared data structure. The locked fetch request provides a simple and low-overhead method of accomplishing this task. When the DMA engine in accordance with such embodiments receives a locked fetch request for a block of memory, it first ensures that no other CPU currently has an outstanding fetch request to that block. It then fetches the block into the associative buffer and returns a response as usual. If another CPU attempts to issue a fetch to the same block while it is being used by the first requester, the DMA engine will simply refrain from returning a response to the new request until the first requester releases the block. As all fetches and stores to a specific block of memory are explicitly signaled to the DMA engine of the present invention via the request queue, it is a straightforward matter to implement this improvement. It is noted that the programmer needs to take the usual precautions to avoid deadlocks. This is relatively straightforward given the constrained workloads of packet processing systems.

In some embodiments, the number of tags examined in the associative buffer tag compare can be reduced by utilizing the notion of working sets that is customarily applied to page tables in memory management systems. As is known, in an associative lookup, all the tags are compared with the requested address concurrently. For example, if there are 128 entries, 128 comparators plus 128-way decode logic would be required to determine which of the tags results in a hit, which increases the complexity. When applying the working set concept, only the tags referenced by a single thread are considered. Typically this is one-fourth to one-sixteenth of the number of buffers in the associative array. The reduction in the number of tags compared concurrently will typically enable the DMA engine to operate at a higher frequency.

Typically, each CPU will operate on a small set of associative buffer entries at a time to perform a single stage in a packet processing task. It is therefore not necessary to build a single large associative buffer array; instead, it can be broken up into several sets of associative buffers, each holding the working set for a given packet processing task. As requests and responses are processed by the DMA of the present invention, the context state determines which working set tags to use. This is similar to the simulation of a fully-associative cache by an N-way set-associative cache, except that the tags for each set are organized by working set rather than by memory address. A fully associative lookup is still required at time of initial request to resolve references to the same location but this is not time critical and can be optimized for size, not speed and can be pipelined. Not sure how much detail is required. The DMA engine may be configure to keep track of the current working set.

Careful programming can prevent deadlock in the above-described embodiments. But to remove one possible source of deadlock, separate data store and data fetch queues can be implemented. Furthermore, rather than a writeback associative buffer, a write-through policy can be used. This may simplify data consistency issues for adjacent but unrelated data structures. This also makes the associative compare logic faster, and further allows for a simpler de-allocation model along the lines of garbage collect.

A DMA engine, in accordance with the present invention as described above and shown in FIGS. 1 and 2 is a general-purpose and flexible apparatus that may be applied to a number of systems and situations. Some of which are described here.

Network Processors

Network processors, or NPs, are an emerging area in the field of communications. Traditionally, NPs combine a programmable core or engine, associated with appropriate network interfaces and processing hardware. The programmable cores used in NPs have usually been standard CPUs, allowing the NPs to be programmed to implement specific applications with well-known tools and techniques. However, one serious problem with standard CPUs is that their memory hierarchies (registers, caches, memory interfaces, etc.) have not been heretofore designed for the specific needs of protocol processing, as encountered in networking situations. Therefore, their performance suffers significantly as the data rates to be handled rise and the access latencies of the external memories (usually, Synchronous Dynamic RAM, or SDRAM) increases relative to the data rate.

Traditional caches are unsuitable for dealing with this issue. Traditional DMAs, too, are not well suited for the purpose, as they are cumbersome and require substantial amounts of bookkeeping overhead (especially if packet modifications are required during processing). The prior art has, therefore, focused on off-loading some of the more onerous tasks from the CPUs using dedicated and specialized hardware accelerators that are custom-designed for one or more tasks that are particularly difficult to implement efficiently on a standard CPU. Unfortunately, the use of such dedicated hardware means that the general-purpose nature of the network processor is lost, as a change in the protocol typically results in the dedicated hardware becoming useless.

The DMA engine of the present invention provides a simple but highly general means of overcoming this limitation. Essentially the DMA engine allows the CPU to eliminate the effects of memory latency on the processing throughput by enabling efficient software scheduling and thread switching mechanisms to be used without necessitating a true hardware-based simultaneous multi-threading CPU. This in turn means that the CPU software is able to run more efficiently and support a much higher data rate. In many cases, therefore, the need for the dedicated hardware accelerators vanishes and the network processor can be kept general and universally applicable.

Lookup and Search Engines

Higher-layer networking protocols typically make use of complex addressing and classification schemes, requiring correspondingly complex search operations over large datasets. These search operations are not easy to implement in fixed-function hardware, and therefore render software-programmable lookup and search engines of significant value. A difficult problem, however, is that the large size of the data sets mandates the use of relatively long-latency memories (e.g., SDRAM), but the nature of the addressing and classification schemes results in relatively small data structures (4-64 bytes) with low locality. Packet processing workloads cannot assume that addresses and classification types in consecutive packets bear any predictable relationship to each other. In the worst case (e.g., Ethernet), packet addresses may be essentially randomly distributed over a very large space. As a consequence, attempting to speed up such search operations using standard cache technology results in no performance gains, and potentially even performance loss, because of cache thrashing. The traditional response has been to design and implement these search operations in dedicated hardware directly interfaced to the external memories. However, this approach is quite inflexible and expensive. It would be greatly preferable to allow the software on the CPU to implement the search operations directly, but without losing performance and efficiency.

The DMA engine of the present invention provides a straightforward method of accomplishing this. Software on the CPU can generate fetch requests to the DMA engine to access portions of the addressing and classification datasets in accordance with the search algorithm. The DMA engine will fetch the requested data and then notify the CPU, allowing the latter to proceed with the next step of the search algorithm. The support for multi-thread operation allows the CPU to maintain multiple concurrent searches (for instance, by processing multiple packets in parallel), thereby hiding the memory access latency.

Monitoring Processors

Operations, administration, maintenance and provisioning (OAM&P) tasks are critical to the proper functioning of networks. These tasks often require that incoming packets be scanned and inspected for various operational and error conditions, with complex algorithms being executed in order to determine these conditions and respond to them properly. For example, certain packets (or bits within packets) may carry signaling information; such data must be removed from the normal data stream and processed appropriately. As another example, the user data packets may need to be categorized and counted, with alarms being generated to the system administrator when counts in certain categories are exceeded.

In modem networking protocols, however, the OAM&P tasks are quite complex and frequently must be implemented in software on a general-purpose CPU. For low data rates, this is a viable approach that has been widely used. However, it becomes a significant problem as the data rates increase, because the efficiency of the general-purpose CPU while processing packets for OAM&P information is significantly impacted by memory latency; as a result, OAM&P information may be lost, which in turn can lead to failures in the network.

The DMA engine of the present invention may be utilized to avoid this problem. The OAM&P software can employ its capabilities to hide the effect of memory latency and improve efficiency, permitting the OAM&P data to be processed without loss. Further, OAM&P tasks are typically carried out over multiple concurrent flows of traffic; this matches very well with the augmented DMA controller, which permits multiple concurrent threads of processing to be supported on a single CPU. Therefore, the use of the present invention will permit a significant increase in efficiency for OAM&P tasks that are executed on a general-purpose CPU.

FIG. 4 shows a general purpose multi-port protocol processor 400, that is capable of handling a variety of networking protocols and functions, and that is adapted to embody the DMA engine 410 of the present invention in conjunction with two standard general-purpose CPUs 402, 412. Multi-port protocol processor 400 further includes a set of one or more network port interfaces 425 that serve to implement the low-level functions and physical interface functions required to accept and generate data streams to an external network. For instance, these could typically be Ethernet Medium Access Control (MAC) units, or SONET framer/payload-processor units.

Each of CPUs 402, 412 includes its own cache hierarchy (level-I and level-2 cache) that supports the general-purpose programming requirements of the software. Switch fabric interface 418 connects the device to an internal switching fabric or other interconnection method, so that the device may exchange data with other devices.

DMA engine 410 is interfaced to both of the CPUs 402,412 and accepts and processes fetch and store requests from the two CPUs, loads or stores data from/to the external memory as per the requests, and returns the responses to the appropriate CPU. In addition, the DMA engine also receives data read/write requests from the CPUs, and returns or updates the appropriate data words.

Memory interface 418 is shared in common by all of the blocks disposed in multi-port protocol processor 400. The memory interface connects to a standard synchronous DRAM memory that contains the packets received from the network ports and the switch fabric port, as well as the context information and other state information required to process these packets.

The operation of the multi-port protocol processor 400 is as follows. Packets received from the network ports by the network port interfaces 425 are placed in to the external synchronous DRAM 420. These are then accessed and processed by one or the other (or both) CPUs utilizing the DMA engine 410 to effectively eliminate the effects of the long memory latency of the synchronous DRAM 420. Once the processing is complete, the packets are sent out to the switch fabric interface 418. Transmitted packets follow an identical sequence of operations, but in the reverse direction—i.e., from switch fabric port to one or the other of the network ports.

The incorporation of the DMA 410 in the embodiment 400 serves three purposes. Firstly, it permits the CPUs to hide the effect of memory latency by requesting data to be fetched in advance, in a manner similar to a software-controlled prefetch but with explicit indication of when the prefetch completes. Secondly, it supports a thread-based programming model that ensures that the CPUs do not remain idle while data are being fetched, without forcing the CPUs to implement simultaneous multi-threading hardware support. Thirdly, it allows the CPUs to pass packet data between each other without overhead, and automatically share and balance the workload between each other. A CPU that is free will automatically pick up the next item of work (together with the packet context required to perform the work) from the augmented DMA controller's response queue.

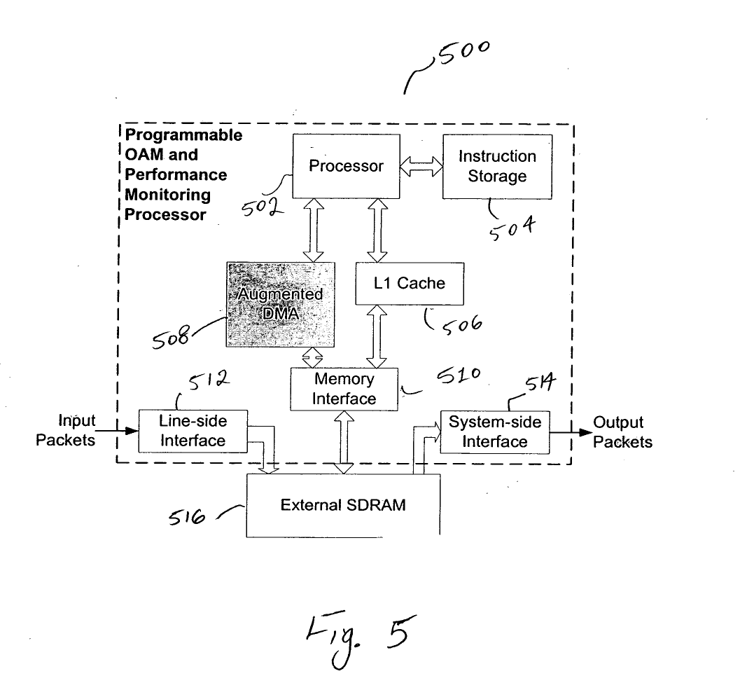

FIG. 5 is a high level block diagram of a programmable engine 500 embodying a DMA engine, in accordance with the present invention, and configured to implement Operations, Administration and Management (OAM) and Performance Monitoring (PM) functions on an incoming packet stream that is received from a network interface. Programmable engine 500 is shown as including, in part, a processor (CPU) 502, with an associated cache 506, a DMA engine 508 in accordance with the present invention, a line-side interface 512 configured to receive packets from a network interface, a system-side interface 514 configured to transfer packets to an output interface (either another network interface, a switch fabric interface, or another processing device), an instruction storage area 504 configured to contain the program code executed by the CPU, and a memory interface 510.

The implementation of OAM and PM functions is relatively complex because of the involved nature of these functions, and also because of the large number of protocols required to be supported by a typical network line card. (Each protocol usually defines its own set of OAM and PM functions.) It is therefore advantageous to implement these functions as software running on a general-purpose CPU.

However, implementation of these functions requires frequent access to a large number of small data structures, such as counter variables, address table entries, policing buckets, etc., that must be located in an external SDRAM due to the size of the data set. Due to the small size and large number of these structures, there is a low degree of locality, and a standard cache is not effective at improving the efficiency of the CPU's accesses. However, at relatively higher network rates such as 622 Mb/s and above, the performance degradation caused by direct accesses to SDRAM by the CPU does not permit the desired level of throughput to be maintained. As a consequence, it has been normal in the prior art for these OAM and PM functions to be implemented in dedicated hardware. However, dedicated hardware becomes very complex and costly when multiple protocols are to be supported, or when protocol changes are to be accommodated.

A DMA engine, in accordance with the present invention, may therefore be used to achieve the necessary increase in processing efficiency, allowing the system to process high data rates without requiring an excessively large and costly CPU, or requiring that all of the OAM and PM functions be implemented in hardware. This in turn permits the system to adapt to protocol changes and implement support for multiple protocols within one device.

The DMA engine disclosed herein represents a relatively simple yet highly capable variation on both a traditional cache and a traditional DMA subsystem. It can be advantageously applied to a variety of protocol processing applications, as it has the generality of a cache (which is transparent to the data being processed) but the efficiency of a DMA controller (which is typically obtained by means of specialized hardware adapted to a particular protocol or processing algorithm). Due to its simplicity, it is also capable of being applied to high-speed packet processing systems, where more complex DMA elements may not be usable. Further, it avoids the hardware-intensive nature of caches, which is a consequence of the cache's need to guess the data to be fetched or stored. As the software is directly involved in the fetch/store decisions, the hardware can be considerably reduced without loss of performance.

One advantage of the DMA engine of the present invention compared to conventional systems is its ability to function efficiently when dealing with a wide variety of data structures, access patterns, and programming models. For instance, lower-level protocol processing (such as Layer 2 or Layer 1 processing) demands that relatively small pieces of data be fetched frequently. This type of processing is unsuited to cache structures, which function better with larger data structures possessing higher locality. On the other hand, higher-level protocol processing (e.g., TCP/IP) entails handling larger chunks of data that have high locality, but need to be extensively modified and resized. This is not well handled by traditional DMA systems, that are better at data copying than data modification and buffer resizing. The DMA engine of the present invention includes the combined features of a fully-associative cache and a DMA controller, and can be used efficiently in both situations. Thus the DMA controller engine of the present invention is easily applied to devices or products which are required to handle a variety of different protocol processing functions efficiently. Examples of such product areas are network processors, protocol accelerators, and network switching elements.

A further advantage of the DMA engine of the present invention compared to conventional systems is its ability to support a low-overhead simultaneous multi-threading model on one or more conventional CPUs without hardware-based context switching capability, in a network processing environment. The context required by each thread of execution is passed back and forth between the DMA engine and the CPU(s) via the request and response queues, with the data required by each thread being guaranteed to be available to the thread when it is made ready to run. This results in the simplicity of programming and high tolerance to memory latency of simultaneous multi-threading systems without the substantial increase in hardware cost and complexity.

Another advantage of the DMA engine of the present invention compared to conventional systems is its ability to efficiently and transparently load-share a given workload over multiple CPUs in a networking environment. In a system with multiple CPUs, all idle CPUs will constantly poll the response queue of the DMA engine of the present invention for work to be performed. The first CPU to receive an item from the response queue will become busy, while the remainder will continue to poll. The workload hence self-balances over all of the available CPUs. It is not necessary for any CPU to explicitly pass an item of work to another, or to perform load-balancing operations. Further, packet and other data required to complete a task are automatically passed from one CPU to another without requiring explicit programmer intervention.

Yet another advantage of the DMA engine of the present invention compared to conventional systems is its ability to simplify interaction between software (on the CPU(s)) and hardware. In a multi-CPU system that also includes hardware elements such as switch fabric interfaces and MAC logic, it is necessary to pass data items between CPUs and between a CPU and a hardware element. Caching such data items results in a high overhead due to the need to maintain cache consistency; not caching such data items has heretofore implied a significant performance loss. The DMA engine of the present invention enables the benefits of caching to be obtained without losing the simplicity and determinism of direct memory reads and writes.

The above embodiments of the present invention are illustrative and not limiting. Various alternatives and equivalents are possible. The invention is capable of supporting a wide variety of protocol processing functions, such as improving the efficiency of protocol processing when using memories, such as Dynamic RAMs (DRAMs), that have high read and write latencies. The invention may be applied to support protocol processing on clusters of tightly-coupled CPUs, such as may be found in multiprocessor systems. It is also capable of supporting a decoupled, thread-based execution model that can be used to improve efficiency even further when dealing with long and unpredictable delays encountered while fetching data. The invention require low overhead and may be implemented as part of a standard CPU. The invention is not limited by the rate used to transfer the data. The invention is not limited by the type of integrated circuit in which the present disclosure may be disposed. Nor is the disclosure limited to any specific type of process technology, e.g., CMOS, Bipolar, or BICMOS that may be used to manufacture the present disclosure. Other additions, subtractions or modifications are obvious in view of the present disclosure and are intended to fall within the scope of the appended claims.

What is claimed is:

1. An apparatus comprising:
a direct memory access controller configured to write data to or retrieve data from a random access memory (RAM) unit; and
an associative memory buffer coupled to direct memory access controller and configured to store the data retrieved from the RAM unit or data to be stored in the RAM unit.

2. The apparatus of claim 1 further comprising:
a first request first-in-first-out (FIFO) configured to store a plurality of data transfer requests from a processor unit; and
a first response FIFO configured to store completion status of a second plurality of data transfer requests.

3. The apparatus of claim 2 wherein each data transfer request comprises an address in the RAM unit, a block size specifying amount of data to be transferred, and context information.

4. The apparatus of claim 1 wherein said associative memory buffer comprises N ports, the apparatus further comprising:
N request first-in-first-out (FIFO) buffers configured to store a plurality of data transfer requests from one or more processor units; and
M response FIFO buffers configured to store completion status of a second plurality of data transfer requests from the one or more processor units.

5. The apparatus of claim 4 wherein M is one.

6. The apparatus of claim 3 wherein said direct memory access controller is configured to inspect contents of the associative memory buffer prior to loading data from the RAM unit or storing data in the RAM unit.

7. The apparatus of claim 6 wherein in response to a load request from the processor unit, the direct memory access controller is caused to return an immediate response if the requested data is present in the associative buffer.

8. The apparatus of claim 7 wherein in response to a store request from the processor unit, the direct memory access controller is caused to take no action if the associative buffer indicates that the requested data has not been modified since it was fetched from external memory.

9. The apparatus of claim 8 wherein said context information is configured to enable the requests to be uniquely identified and further to be correlated to returned responses.

10. The apparatus of claim 9 wherein said context information is further configured to enable the requests to be uniquely identified and further to be correlated to returned responses.

11. The apparatus of claim 1 wherein said associative memory buffer comprises N ports, the apparatus further comprising:
a plurality of request first-in-first-out (FIFO) buffers configured to store a plurality of data transfer requests from a plurality of processor units; and
a plurality of response FIFO buffers configured to store completion status of a second plurality of data transfer requests from the plurality of processor units, wherein each data transfer request comprises an address in the RAM unit, a block size specifying amount of data to be transferred, and context information.

12. The apparatus of claim 11 wherein said context information is further configured to enable context switching between a plurality of concurrent threads operating in parallel on the plurality of processors.

13. The apparatus of claim 12 wherein said RAM unit is external to the DMA engine.

14. The apparatus of claim 13 wherein said associative memory buffer comprises a tag compare logic configured to perform a reduced number of compare operation on its associated tags and in accordance with a working set defined by the context information.

15. A method of processing data, the method comprising:
receiving a request to fetch data from an address in a first memory;
allocating a block of an associative memory to hold the fetched data;
loading the fetched data in the allocated block.

16. The method of claim 15 wherein said request comprises an address in the first memory, a block size specifying the size of the allocated block, and context information.

17. The method of claim 16 further comprising:
storing the context information associated with the request in a second memory.

18. The method of claim 17 further comprising:
reading the stored context information from the second memory;
accessing the requested data from the first memory address;
trapping the requested access; and
directing the read request to allocated block of the associative memory buffer.

19. The method of claim 18 further comprising:
retiring the read request; and
freeing the allocated space in the associative memory buffer.

20. The method of claim 19 wherein said second memory is a first-in-first-out (FIFO) buffer, the method further comprising:
storing the request in a first one of a first one of a plurality of FIFO buffers; and
storing a completion status associated with the request in a second one of a plurality of FIFO buffers.

21. The method of claim 20 wherein said associative memory buffer comprises N ports, the method further comprising:
storing a first plurality of requests in said first plurality of FIFOs; and
storing a first plurality of completion status in said second plurality of FIFO.

22. The method of claim 21 further comprising:
inspecting contents of the associative memory buffer prior to loading data from the first memory or storing data to the first memory.

23. The method of claim 22 further comprising:
returning an immediate response if the requested data is detected as being present in the associative buffer upon the inspection.

24. The method of claim 23 further comprising:
causing no further action if the associative buffer indicates that the requested data has not been modified since it was fetched from first memory.

25. The method of claim 24 said context information is configured to enable the requests to be uniquely identified and further to be correlated to returned responses.

26. The method of claim 25 further comprising:
enabling context switching between a plurality of concurrent threads operating in parallel.

27. The method of claim 26 further comprising:
performing a reduced number of tag compare operation in accordance with a working set defined by the context information.
